(19) United States
(12) Patent Application Publication
(10) Pub. No.: US 2008/0086887 A1
(43) Pub. Date: Apr. 17, 2008

(54) Modular grooming tool

(76) Inventors: Sung K. Park, Waban, MA (US); Douglas C. Dayton, Harvard, MA (US)

Correspondence Address: Mintz, Levin, Cohn, Ferris,;Glovsky and Popeo, P.C., One Financial Center, Boston, MA, 02111, US

(21) Appl. No.: 11/800,470

(22) Filed: May 4, 2007

Related U.S. Application Data
(60) Provisional application No. 60/798,349, filed on May 5, 2006.

(51) Int. Cl. B26B 19/02

(52) U.S. Cl. 30/29.5

(57) ABSTRACT

A modular hair grooming tool comprising a razor assembly coupled to a first end of the hand-piece such that the razor assembly is removable, and a nose/ear hair trimmer coupled to the first end of the hand-piece. The nose/ear hair trimmer is configured to couple with the razor assembly to nest within the razor assembly while the razor assembly is coupled to the first end of the hand-piece.

### RELATED APPLICATIONS

This application claims priority to U.S. provisional patent application Ser. No. 60/798,349, filed May 5, 2006, the entire disclosure of which is herein incorporated by reference.

### TECHNICAL FIELD OF THE INVENTION

The invention relates to a multi-function modular hair grooming tool.

### BACKGROUND

Most people have many different devices in their homes, in their cars, at work, or carried with them for ongoing personal grooming purposes requiring the purchase, management and maintenance of sometimes redundant mechanisms. In addition, many grooming implements can benefit from improved function by the addition of a motor to drive the grooming implement and to provide higher efficiency. Many grooming implements, however, do not include a motor and drive system due to their impractical costs.

### SUMMARY

In general, in an aspect, the invention provides a system for a modular hair grooming tool. The system comprising a hand-piece for holding the tool, a razor assembly coupled to a first end of the hand-piece such that the razor assembly is removable, and a nose/ear hair trimmer coupled to the first end of the hand-piece. The nose/ear hair trimmer is configured to couple with the razor assembly to nest within the razor assembly while the razor assembly is coupled to the first end of the hand-piece.

Implementations of the invention may include one or more of the following features. The system further comprises a beard trimmer coupled to a second end of the hand-piece, and a protective cap removably coupled to the second end of the hand-piece and configured to cover the beard trimmer while coupled to the second end of the hand-piece. The system is configured to be battery powered and includes a power switch disposed along a surface of the hand-piece. The hand-piece further includes an electric motor and appropriate gear train to provide reciprocating motion to the beard trimmer and the electric motor is further configured to provide rotary motion to the first end of the hand-piece. The razor assembly further comprises an eccentric weight connected to a flywheel. The razor is configured to allow the user to couple the razor to the protective cap on the second end of the hand-piece.

The invention provides a modular approach to a suite of hair grooming tools, creating a universal range of interchangeable implements. Such implements utilize one motor and drive system, thus minimizing the cost impact to each. The modular approach achieves high efficacy across the range of implements, as well as creates a more manageable system of hair grooming tools.

Various aspects of the invention may provide one or more of the following capabilities. A modular hair grooming tool may be provided that utilizes various interchangeable implements that perform a range of grooming functions. A motor powered grooming tool may also be provided. The powdered grooming tool may provide a reciprocating motion to one implement at one end of the tool and a vibrating motion to another implement at an opposite end of the tool. A portable, battery powered modular grooming tool may be provided. A modular grooming tool may be provided in which some of the grooming implements may be nested one inside the other. The modular grooming tool may apply a vibration to one or more of the implements, heads, or tools coupled thereto.

These and other capabilities of the invention, along with the invention itself, will be more fully understood after a review of the following figures, detailed description, and claims.

### BRIEF DESCRIPTION OF THE FIGURES

FIG. 1 is an exploded perspective view of a multi-function modular hair grooming tool.

FIG. 2 is an exploded perspective view of the multi-function modular hair grooming tool shown in FIG. 1 including a beard trimmer.

FIG. 2A is an exploded perspective view of the multi-function modular hair grooming tool shown in FIGS. 1 and 2 including the beard trimmer and a nose/ear hair trimmer.

FIG. 3 is an exploded perspective view showing interior drive system components of the modular hair grooming tool shown in FIGS. 1, 2 and 2A.

FIG. 4 is an exploded perspective view which depicts a drive mechanism which connects the vibrating shaving head implement to the grooming tool.

### DETAILED DESCRIPTION

The multi-function modular hair grooming tool is a portable, battery powered tool that combines a plurality of hair grooming implements on a single end of the tool through the use of a nesting configuration and the appropriate torque drive connections within the nested components.

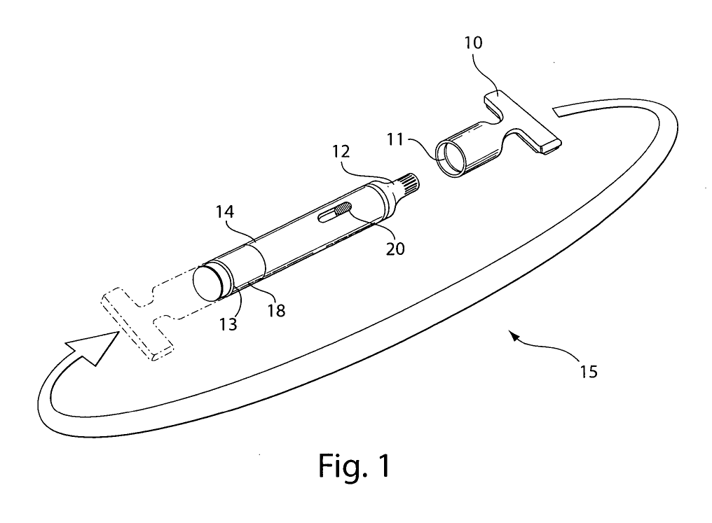

Referring to FIG. 1, an exemplary embodiment of a modular hair grooming tool 15 includes a hand-piece/body 14, a razor assembly 10, a nose/ear hair trimmer 12, a receiving feature 13, and a protective cap 18. The modular hair grooming tool 15 is configured to power various interchangeable grooming implements. The modular hair grooming tool 15 is also configured to allow the nose/ear hair trimmer 12 to nest inside of the razor assembly 10 implement. The protective cap 18 is configured to cover a beard trimmer, as described below. The hand-piece 14 is configured to contain a power source, such as a battery, and a motor that may contain a transmission gear train. The transmission gear train may be configured to provide mechanical motion to both ends of the modular hair grooming tool 15.

The hand-piece 14 includes a power switch 20 disposed such that a portion is exposed along a surface of the body of the hand-piece 14 for actuation and is operatively connected to an internal switch and/or electrical component(s) that facilitate “ON/OFF” operation(s) or mode(s) and/or other functions of the tool 15. The power switch 20 may be configured to select operation of the beard trimmer, as described below, or the nose/ear hair trimmer 12, and the vibratory razor assembly 10, if attached. The power switch 20 may also be configured to activate both the beard trimmer, as described below, and the nose/ear trimmer 12, and the vibratory razor assembly 10, if attached at the same time.

The razor assembly 10 is configured and disposed to act as a conventional safety razor. In addition, the razor assembly 10 includes an eccentric weighted cam, as described below, that provides vibration to a razor head of the assembly 10 when the assembly 10 is attached to a torque drive connection of the nose/ear hair trimmer 12. The razor assembly 10 also includes a conventional safety razor cartridge that may be replaceable.

The razor assembly 10 is configured to fit over the nose/ear hair trimmer 12, while the razor assembly 10 is in an active position, e.g., vibrating, during us. A razor coupling 11 may be configured to be quickly detachable from the nose/ear hair trimmer 12 by any of various methods including, but not limited to, a flexing interference fit, a bayonet style attachment, a quarter turn thread with detent, a spring loaded ball detent with a registration feature or many others. The razor assembly 10 may also be placed in a storage or non-vibratory position over the receiving feature 13 disposed along the opposing end of the modular hair grooming tool 15. The movement of the razor assembly 10 by a user from covering the nose/ear hair trimmer 12 to a storage position on the receiving feature 13 allows the user access to and the use of the nose/ear hair trimmer 12.

The nose/ear hair trimmer 12 is configured and disposed to act in a manner consistent with a conventional nose/ear hair trimmer when the razor assembly 10 is removed from covering the nose/ear hair trimmer 12. The nose/ear hair trimmer 12 utilizes the rotary motion output of an electric motor, as described below, contained within the hand-piece 14 to drive a nose/ear hair cutter, as described below, in a rotary motion.

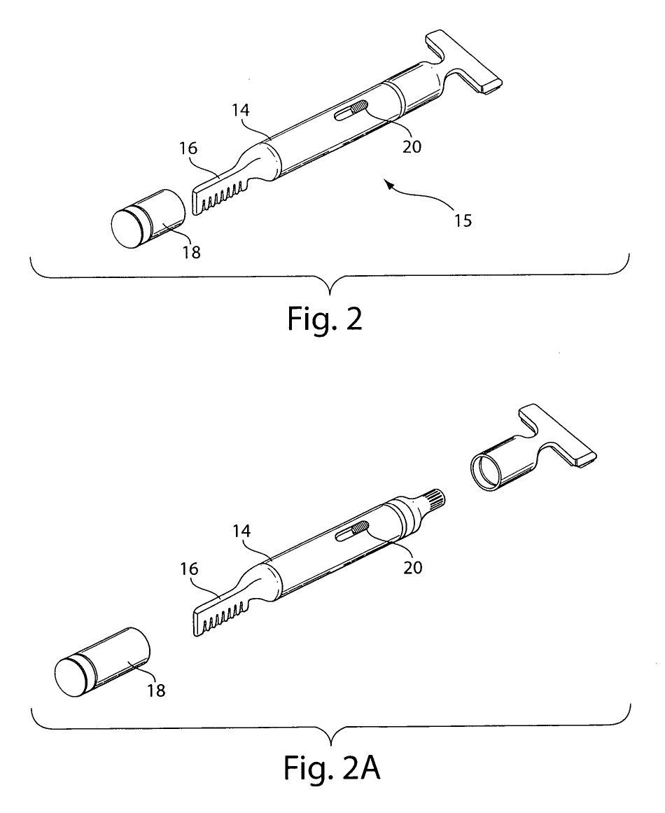

Referring to FIG. 2 with further reference to FIG. 1, the modular hair grooming tool 15 of FIG. 1 further includes the beard trimmer 16, such that, the modular hair grooming tool 15 incorporates the hair removal functions of shaving, beard trimming and nose/ear hair removal. The razor assembly 10, as described above with respect to FIG. 1, is attached to the hand-piece 14 in a position that covers the nose/ear hair trimmer 12 and allows the nose/ear hair trimmer 12 implement to nest inside of the razor assembly 10. The protective cap 18 is removed to allow access to the beard trimmer 16. Referring to FIG. 2A, both the protective cap 18 and the razor assembly 10 are removed to expose and allow access to the beard trimmer 16 and the nose/ear hair trimmer 12, respectively.

The power switch 20 is disposed such that at least a portion is exposed along a surface of the body of the hand-piece 14 and is operatively connected to an internal switch and/or electrical component(s) that facilitate “ON/OFF” operation(s) or mode(s) and/or other functions. The power switch 20 may be configured to select either operation of the beard trimmer 16 or the nose/ear hair trimmer 12, and the vibratory razor assembly 10, if attached. The power switch 20 may also be configured to activate both the beard trimmer 16 and the nose/ear trimmer 12, and the vibratory razor assembly 10, if attached at the same time.

The beard trimmer 16 is configured and disposed to act in a manner consistent with a conventional shuttle bar cutter for beards and facial hair. The hand-piece 14 may be configured to provide the required reciprocating motion to the beard trimmer 16. The beard trimmer 16 may be removable to provide access to a battery compartment and the beard trimmer 16 may be driven with a connecting rod and a spring loaded paddle drive mechanism. Alternatively, the rotary motion of the motor may be carried to the end of the device with a non-removable right angle and reciprocating drive and battery access may be provided by a door in the side of the hand-piece 14.

The protective cap 18 may be placed over the beard trimmer 16 to cover and to protect the beard trimmer 16. The beard trimmer protective cap 18 is removable and may be configured to be quickly detachable by any of various methods including, but not limited to, a snap feature, friction fit, bayonet style attachment, a quarter turn thread with detent, a spring loaded ball detent with a registration feature or many others.

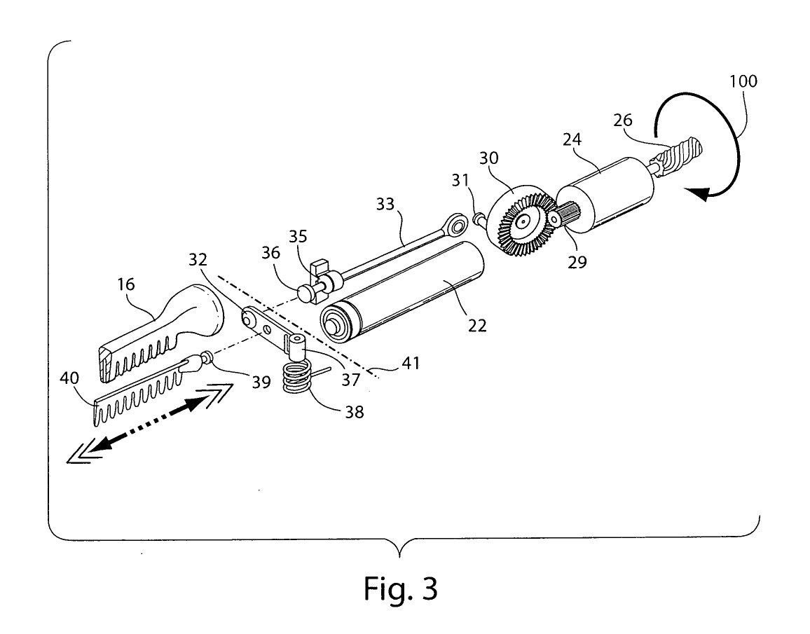

Referring to FIG. 3, and with further reference to FIGS. 1-2A, the modular hair grooming tool 15, may include several internal drive components by which the tool 15 provides rotary motion to the nose/ear hair trimmer 12 and simultaneously reciprocating motion to the beard trimmer 16. The internal drive components include a battery power source 22, an electric motor 24, a cylindrical blade assembly 26, a gear 29, a ring gear 30, a crankshaft 31, a connecting rod 33, a spherical bearing 35, a reciprocating pommel 36, a receiving cup 32, a hinged paddle 37, a return spring 38, a flexible joint 39, and a shutter bar trimmer blade 40.

The hand-piece 14 contains the battery power source 22 that powers the motor 24. The battery power source 22 is shown as a single battery, but various numbers and sizes of batteries may be used, as well as replaceable and/or rechargeable batteries.

The motor 24 may be an appropriately sized DC electric motor, AC electric motor, permanent magnet motor, brushless motor, stepper motor, or other appropriate electric motor for providing rotary motion.

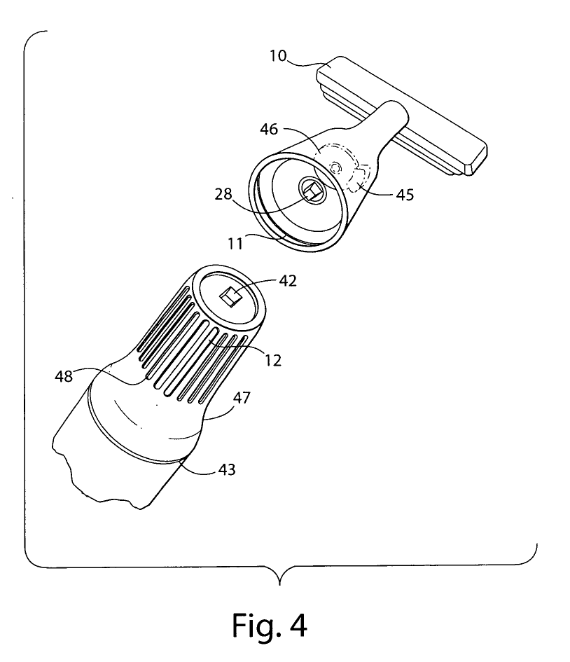

The nose/ear hair trimmer 12 may utilize the cylindrical blade assembly 26 that is configured to rotate, as shown by arrow 100 in FIG. 3, inside a protective slotted housing 47 (shown in FIG. 4) and to trim the nose/ear hairs as the hairs enter apertures 48 (shown in FIG. 4) in the nose/ear hair trimmer slotted housing 47 by shearing contact to the hair between the blade assembly 26 and aperture 48. The nose/ear hair trimmer 12 is driven by an output shaft of the motor directly connected to the cylindrical blade 26 inside the slotted housing. An end of the cylindrical blade assembly 26 may have a connection that allows a connection to a mating feature in the razor assembly 10, as shown in FIG. 4 and described below.

The gear 29 may be connected to an output shaft on the opposite end of the motor 24 from the cylindrical blade assembly 26. The gear 29 can be of various sizes and shapes as long as it is configured to work in conjunction with the ring gear 30 to transform the rotary output motion of the motor 24 ninety degrees or perpendicular to the original output axis. Alternatively, the same effect can be achieved with a double bevel gear configuration.

The ring gear 30 may include a crankshaft 31 which may be configured and disposed to connect to the connecting rod 33 and to provide a reciprocating motion. Alternatively, a cam system or other similar means of creating reciprocating motion might be employed to the same purpose.

The connecting rod 33 may be configured and disposed to act in a manner consistent with a conventional power transmitting connecting rod. The connecting rod 33 as well as most of the drive components may be manufactured from plastic, metal, or other suitable materials. The connecting rod 33 is connected to the crankshaft 31 with a bearing. The connecting rod 33 is constrained at the power delivery end of the connecting rod 33 by a spherical bearing 35 or similar fixture that accommodates the angular deviation of the reciprocating motion of the connecting rod 33. The power delivery end of the connecting rod terminates with a reciprocating pommel 36.

The reciprocating pommel 36 is configured to transfer the drive motion through surface contact to the receiving cup 32 of the hinged paddle 37, that drives the beard trimmer 16. The reciprocating pommel 36 is part of the connecting rod 33 and is not connected to the receiving cup 32. Thus, the hinged paddle 37, which contains the receiving cup 32, may be easily separated from the connecting rod 33 for disassembly.

The shuttle bar trimmer blade 40 may be driven in a reciprocating motion by the hinged paddle 37. The hinged paddle 37 includes the receiving cup 32 for receiving a forward drive motion from the motor 24 and associated drive train. The hinged paddle 37 also includes a return spring 38 that may provide a return drive motion for the hinged paddle 37. The shuttle bar trimmer blade 40 may be attached to the hinged paddle 37 by a flexible joint 39, or sliding ball joint or similar 3-degree of freedom connection that accommodates the lateral translation and flexing motion of the trimmer blade 40 as the blade is constrained by the beard trimmer housing and the paddle 37 travels through its range of motion.

The beard trimmer 16 and the hinged paddle 37 may be removable along a partition line 41 to provide access to the battery 22. Alternatively, in some embodiments, the rotary motion of the motor 24 may be carried to the beard trimmer 16 end of the tool with a non-removable right angle and reciprocating drive-train and battery 22 access could be provided by a door in a side of the hand-piece 14.

Referring to FIG. 4, and with further reference to FIGS. 1 and 3, a vibratory drive mechanism of the razor assembly 10 includes a razor coupling 11, a mating feature 28, a torque drive connection 42, the nose/ear hair trimmer 12, a razor coupling receiving feature 43, an eccentric weight 45, a flywheel 46, a slotted housing 47, and a plurality of apertures 48.

The razor coupling 11 may be configured to mate with the razor coupling receiving feature 43 which allows the razor assembly 10 to securely attach over the nose/ear hair trimmer 12 onto the body of the hand-piece 14. This secure connection allows the nose/ear hair trimmer 12 to transmit torque to the razor assembly 10.

The nose/ear hair trimmer 12 may have a torque drive connection 42 located at the end of the nose/ear hair trimmer 12 and may be recessed into the body of the nose/ear hair trimmer to allow normal use of the nose/ear hair trimmer 12 by the user. The torque drive connection 42 may have various design features for transmitting torque such as, but not limited to, a female socket with a flat side, a key, a pin, a square cross section, or an internal spline. The torque drive connection 42 is preferably recessed into the end of the cylindrical blade assembly 26 and is configured to rotate, as shown by arrow 100 in FIG. 3. The cylindrical blade assembly 26 rotates inside the protective slotted housing 47 to trim the nose/ear hairs as the hairs enter the plurality of apertures 48 in the nose/ear hair trimmer slotted housing 47 by shearing contact to the hair between the blade assembly 26 and aperture 48. The torque drive connection 42 is configured to mate to the mating feature 28 on the razor assembly 10 while the razor assembly 10 is connected over the nose/ear hair trimmer 12.

The mating feature 28 on the razor assembly 10 may be configured to engage the torque drive connection 42 and to be connected to the eccentric weight 45 and flywheel 46 of the razor assembly 10.

The razor assembly 10 includes in an internal area 10A, the flywheel 46 and the eccentric weight 45. The eccentric weight 45 is connected to an outer edge of the flywheel 46. The flywheel 46 and the eccentric weight 45 may impart a controlled vibration to the razor assembly 10 when they are rotated. The flywheel 46 and the eccentric weight 45 may be rotated when they are coupled via the mating feature 28 and the torque drive connection 42 to the rotary motion of the nose/ear hair trimmer 12 and subsequently, the motor 24. Since the flywheel 46 and the eccentric weight 45 are contained within the razor assembly 10, the vibratory motion does not occur when the razor is not coupled to the nose/ear hair trimmer 12.

In general, as shown above, the removal of a detachable tool or implement can reveal below it a ready-to-use tool or implement, which in some instances may itself be detachable to reveal yet a third grooming tool/head below.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A system for a modular hair grooming tool, the system comprising:
a hand-piece for holding the tool;
a razor assembly coupled to a first end of the hand-piece such that the razor assembly is removable; and
a nose/ear hair trimmer coupled to the first end of the hand-piece;
wherein the nose/ear hair trimmer is configured to couple with the razor assembly to nest within the razor assembly while the razor assembly is coupled to the first end of the hand-piece.

2. The system of claim 1 further comprising:
a beard trimmer coupled to a second end of the hand-piece; and
a protective cap removably coupled to the second end of the hand-piece and configured to cover the beard trimmer while coupled to the second end of the hand-piece.

3. The system of claim 2 wherein the system is configured to be battery powered and includes a power switch disposed along a surface of the hand-piece.

4. The system of claim 3 wherein the hand-piece further includes an electric motor and appropriate gear train to provide reciprocating motion to the beard trimmer and the electric motor is further configured to provide rotary motion to the first end of the hand-piece.

5. The system of claim 4 wherein the razor assembly further comprises an eccentric weight connected to a flywheel.

6. The system of claim 5 wherein the razor is configured to allow the user to couple the razor to the protective cap on the second end of the hand-piece.
